(19) United States
(12) Patent Application Publication
(10) Pub. No.: US 2004/0160640 A1
(43) Pub. Date: Aug. 19, 2004

(54) Systems and methods for creating three-dimensional and animated images

(76) Inventors: Richard C. Corrales, Los Angeles, CA (US); Raleigh Souther, Orange, CA (US)

Correspondence Address: Eric K. Satermo, P.O. Box 19099, Irvine, CA, 92623-9099, US

(21) Appl. No.: 10/462,376

(22) Filed: Jun. 16, 2003

Related U.S. Application Data
(63) Continuation-in-part of application No. 09/931,796, filed on Aug. 16, 2001.

(51) Int. Cl. G06K 15/02; G06F 17/00; G02B 27/22

(52) U.S. Cl. 358/1.18; 359/463; 358/1.13

(57) ABSTRACT

A system for producing a three-dimensional or an animated device includes a computer system and a lenticular assembly. The computer system may include a printer, a monitor, a computer, and a digital video camera. Under operation by a user and enablement by accompanying computer code or software, the computer displays a preview window and a plurality of thumbnail windows on the monitor. The user then causes the computer to import a plurality of subject images to the thumbnail windows. The subject images include a subject in front of a temporary background, for example, a “green screen” background. The computer may then import a background image with a replacement background. The computer then generates a composite image by replacing the temporary background with the replacement background and interlacing the subject images. The user may modify and adjust the images as desired, for example, by changing the replacement background. When the composite image is satisfactory, the user may then cause the computer to export the processed image to the printer to generate a print of the processed image. The print may then be mounted to a lenticular sheet, thereby forming an animated or three-dimensional device.

### CROSS REFERENCE TO RELATED APPLICATIONS

This application is a continuation-in-part (CIP) application of U.S. patent application Ser. No. 09/931,796 filed Aug. 16, 2001.

### BACKGROUND OF THE INVENTION

1. Field of the Invention

The present invention relates to three-dimensional and animated images and, more particularly, to systems and methodology for creating such images on a home or office computer without the need of professional imaging services.

2. Description of Related Technology

An anaglyph image is a moving or still picture consisting of two slightly different perspectives of the same subject in contrasting colors that are superimposed on each other, producing a three-dimensional (3D) effect when viewed through two correspondingly colored filters, typically a red and a blue lens of 3D glasses. In other words, anaglyph imaging refers to those moving or still images that need to be viewed with 3D glasses to produce the 3D effect.

An animated image is a series of successive still images superimposed on each other that when view through a special lens (i.e., a lenticular sheet) and rotated about an axis, produce an animated sequence of the images. A 3D image may also be created by using a lenticular sheet, as opposed to 3D glasses.

Conventionally, such specialized imaging techniques required professional imaging services. Accordingly, the cost of producing a unique or customized animated or 3D device is prohibitive to an individual user. In addition, “fine tuning” of the desired image is out of the user's hands, having to depend upon the judgement of the outside professional service.

In view of the foregoing, there is a need in the art for systems and methodology that enable a user to create his or her own animated or 3D image by using only a desktop computer and conventional printer.

### SUMMARY OF THE INVENTION

The present invention provides systems and methods for producing a three-dimensional or an animated device. According to one aspect of the invention, a system includes a computer system and a lenticular assembly. The computer system may include a printer, a monitor, a computer, and a digital video camera. Under operation by a user and enablement by accompanying computer code or software, the computer displays a preview window and a plurality of thumbnail windows on the monitor.

The user then causes the computer to import a plurality of subject images to the thumbnail windows. The subject images include a subject in front of a temporary background, for example, a “green screen” background. The computer may then import a background image with a replacement background. The computer then generates a composite image by replacing the temporary background with the replacement background and interlacing the subject images.

At this time, the user may modify and adjust the images as desired, for example, by changing the replacement background. When the composite image is satisfactory, the user may then cause the computer to export the processed image to the printer to generate a print of the processed image. The print may then be mounted to a lenticular sheet, thereby forming an animated or three-dimensional device.

One of the benefits of the present invention is that a user is able to create animated or three-dimensional devices without the need of professional imaging services, thereby saving the user time and expense while enable the user to modify and amend the images and devices as desired. In addition, each of the steps can be essentially carried out on the computer with a single mouse click or key stroke, thereby rapidly increasing the processing speed over conventional systems. The systems and methods of the invention are particularly beneficial in producing security items, such as identification cards and security badges.

Additional aspects, features, and advantages of the present invention will become apparent to those skilled in the art from a consideration of the following detailed description taken in conjunction with the accompanying drawings.

### BRIEF DESCRIPTION OF THE SEVERAL VIEWS OF THE DRAWINGS

FIG. 1 is a perspective view of an exemplary computer system for creating three-dimensional (3D) and animated prints in accordance with the principles of the present invention;

FIG. 2 is a view of a computer window environment configured according to a preferred embodiment of the invention;

FIG. 3 is a flow chart of exemplary methodology for a user to follow to create 3D and animated prints and images of the invention;

FIG. 4 is a schematic view of a creation-mode window according to a preferred embodiment of the invention, particularly illustrating a 2-flip animation mode window;

FIG. 5 is a schematic view of a creation-mode window according to a preferred embodiment of the invention, particularly illustrating a 3-flip animation mode window;

FIG. 6 is a schematic view of a creation-mode window according to a preferred embodiment of the invention, particularly illustrating a 3D mode window;

FIG. 7 is a schematic view of a creation-mode window according to a preferred embodiment of the invention, particularly illustrating an anaglyph mode window;

FIG. 8 is a flow chart of exemplary methodology for creating animated prints in accordance with the present invention;

FIG. 9 is a view of an interlaced image created according to the invention;

FIG. 10 is a flow chart of exemplary methodology for creating an anaglyph print in accordance with the invention;

FIG. 11 is a plan view of a lenticular assembly configured in accordance with the invention;

FIG. 12 is a cross-sectional view of the lenticular assembly of the invention;

FIG. 13 is a perspective view of a print being mounted to a lenticular sheet in accordance with the invention;

FIG. 14 is a cross-sectional view of a 3D or animated printed mounted to a lenticular sheet according to a preferred embodiment of the invention;

FIG. 15 is a plan view of a lenticular sheet with an adhesive strip according to a preferred embodiment of the invention;

FIG. 16 is a perspective view of a frame including an animated device according to the present invention;

FIG. 17 is a perspective view of stereo viewing glasses for viewing anaglyph prints of the invention;

FIG. 18 is a plan view of a calibration sheet for calibrating lenticular sheets of the invention;

FIG. 19 is a schematic view of a system for creating three-dimensional or animated devices from a plurality of images;

FIG. 20 is a flow chart illustrating methodology for creating three-dimensional or animated devices;

FIG. 21 is a schematic view of an image-processing method of the invention;

FIG. 22 is a schematic view of a system for creating three-dimensional images;

FIG. 23 is a flow chart illustrating methodology for creating three-dimensional images;

FIG. 24 is a schematic view of a photography system of the invention for producing lenticular images, which system is installed as a stand-alone system;

FIG. 25 is a schematic view of a window for playing an instructional movie and a live video feed according to the principles of the invention;

FIG. 26 is a flow chart illustrating methodology for creating animated images with a replacement background with images from a live video feed;

FIG. 27 is a schematic view of a window for showing an animated preview and a plurality of replacement backgrounds according to the invention;

FIG. 28 is a schematic view of a window including a number of tools for modifying a replacement background according to the invention;

FIG. 29 is a schematic view of a window for modifying a print based on lens characteristics;

FIG. 30 is a schematic view of a window for modifying an alignment mark of a print;

FIG. 31 is a schematic view of a window for entering a transaction identification number on a print;

FIG. 32 is a schematic view of a window for enabling a user to save an animated image;

FIG. 33 is a schematic view of a window for modifying the printing of a transaction ID on a print; and

FIG. 34 is a schematic view of a window for enabling the selection of an instructional movie.

### DETAILED DESCRIPTION OF THE INVENTION

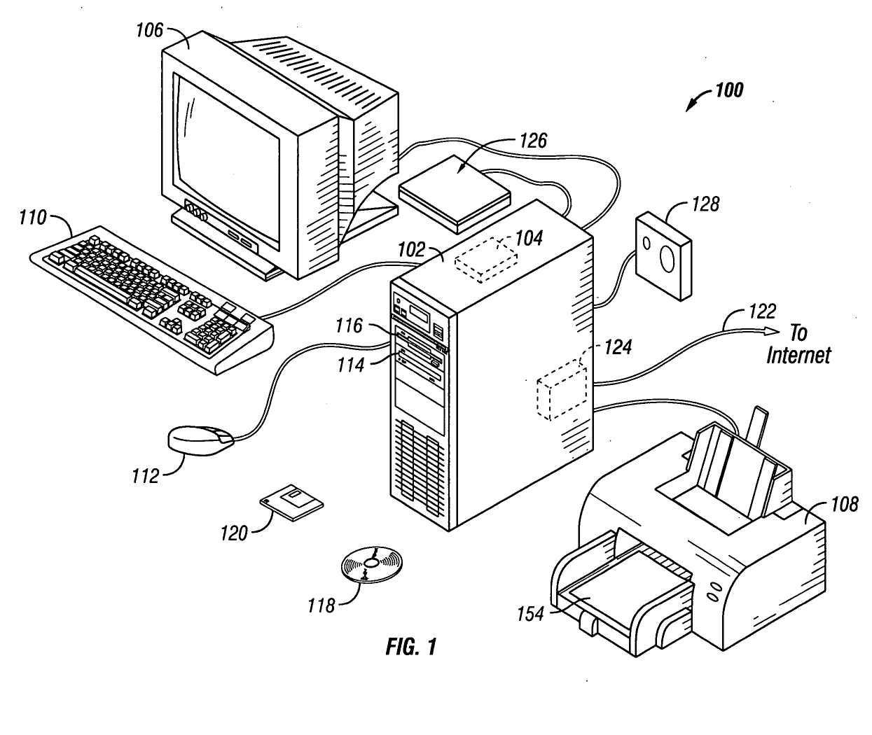

Referring more particularly to the drawings, an exemplary embodiment of a computer system for creating three-dimensional (3D) and animated images in accordance with the principles of the present invention is illustrated in FIG. 1 and indicated with reference numeral 100. A user may utilize exemplary computer system 100 to create his or her own 3D and animated prints economically at home or office and without the need of professional image services.

Exemplary system 100 includes a computer 102 with a processor 104, a monitor 106, and a home or office printing machine such as a printer 108. Interface devices such as a keyboard 110 and a mouse 112 allow a user to interact with the system. Instructions in the form of computer code may be downloaded into computer 102 via a compact disc read-only memory (CD-ROM) drive 114 or a floppy drive 116 for respectively receiving a complementary computer-readable storage medium such as a CD-ROM 118 or a floppy disc 120. Alternatively, computer code may be downloaded into computer 102 through an Internet connection 122 as known in the art. In addition, computer 102 may include a hard disc 124 on which computer code may be stored or “bundled.” Peripherals such as a scanner 126 and a digital camera 128 may also be connected to the system. The plurality of computer-readable instructions cause the processor 104 to operate the system 100 in accordance with the methodology of the invention, which is discussed in detail below.

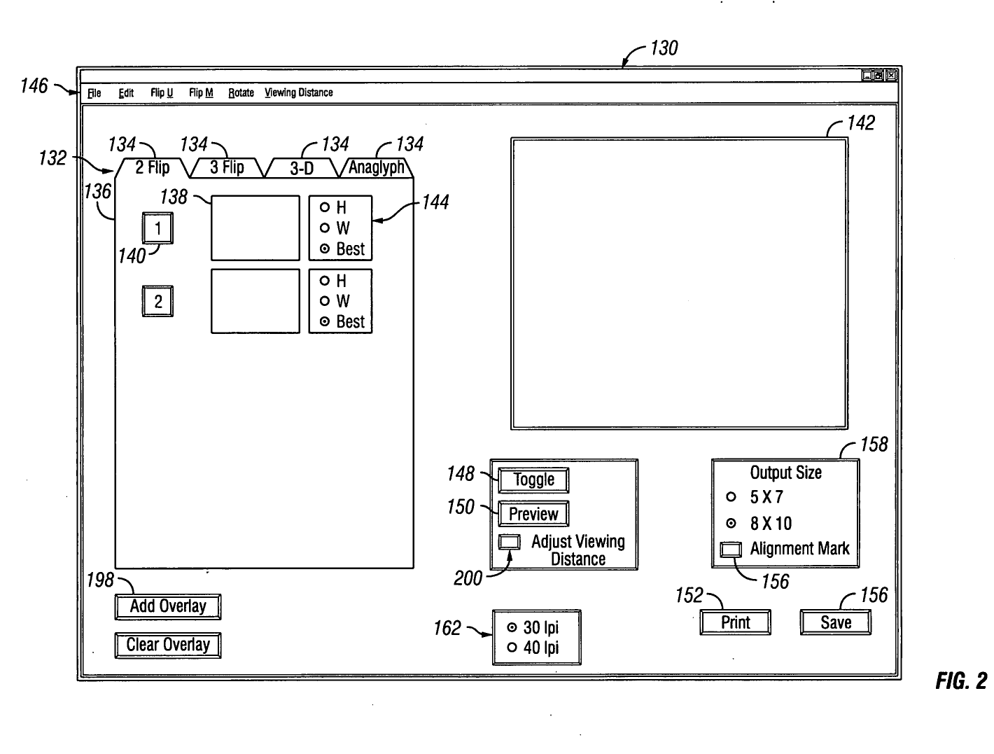

With additional reference to FIG. 2, in accordance with an exemplary embodiment of the invention, a working screen 130 is displayed on the monitor 106. The screen 130 includes a plurality of windows with which a user may create an animated or a 3D image. More particularly, a selection window 132 provides a number of creation-mode selections from which a user may chose. In the preferred embodiment shown, for example, tabs 134 are provided for a 2-flip animated mode, a 3-flip animated mode, a 3D mode, and an anaglyph mode.

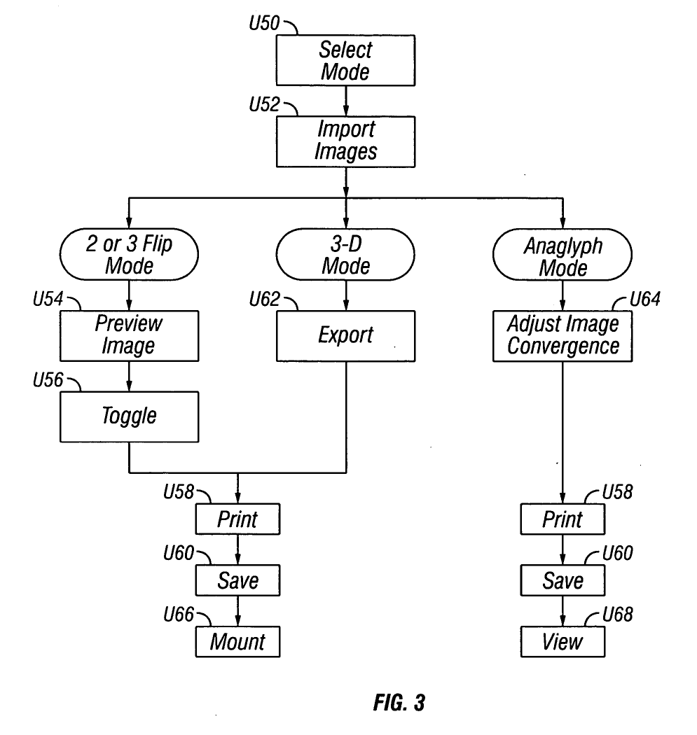

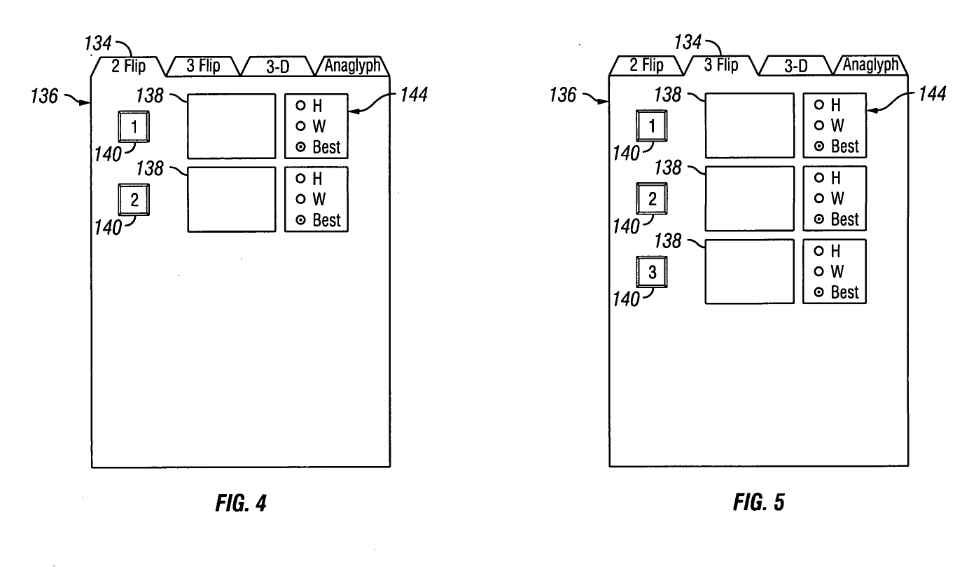

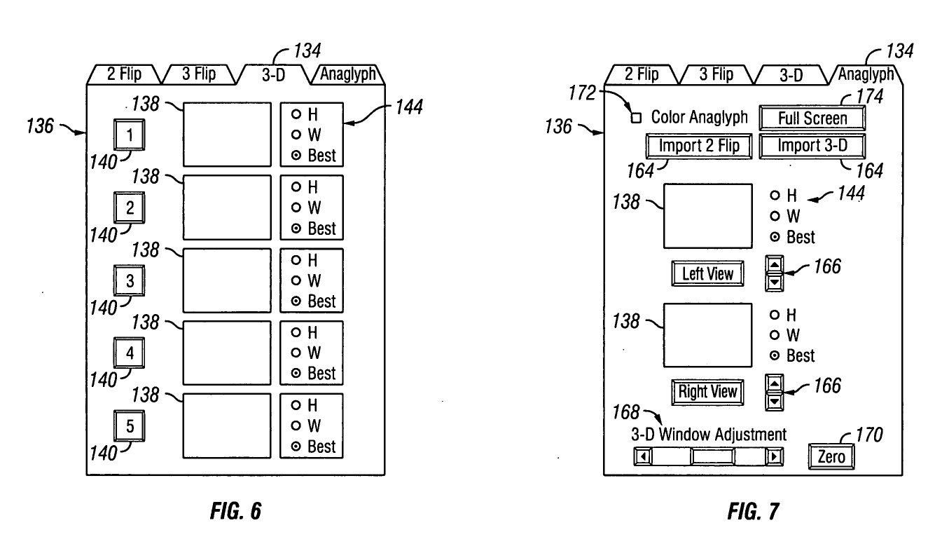

With additional reference to FIG. 3, when a user selects one of the creation modes (step U50) by, e.g., clicking on one of the tabs 134 with the mouse 112, a tab-specific mode window 136 is activated. More specifically, if the 2-flip tab 134 is selected, then a 2-flip mode window 136 as shown in FIG. 4 is displayed; if the 3-flip tab 134 is selected, then a 3-flip mode window 136 as shown in FIG. 5 is displayed; if the 3D tab 134 is selected, then a 3D mode window 136 as shown in FIG. 6 is displayed; and if the anaglyph tab 134 is selected, then an anaglyph mode window 136 as shown in FIG. 7 is displayed.

Once the creation mode is selected, then a user may import images (step U52) to thumbnail windows 138 within the mode window 136. For example, a user may activate a file-location browser window as known in the art (not shown) by clicking on an import button 140. The user may then drag and drop an image from a file location on the hard drive 124 of the computer 102. Alternatively, image files may be downloaded or imported from a remote source such as the Internet 122, the scanner 126, the digital camera 128, or one of the drives 114 or 116.

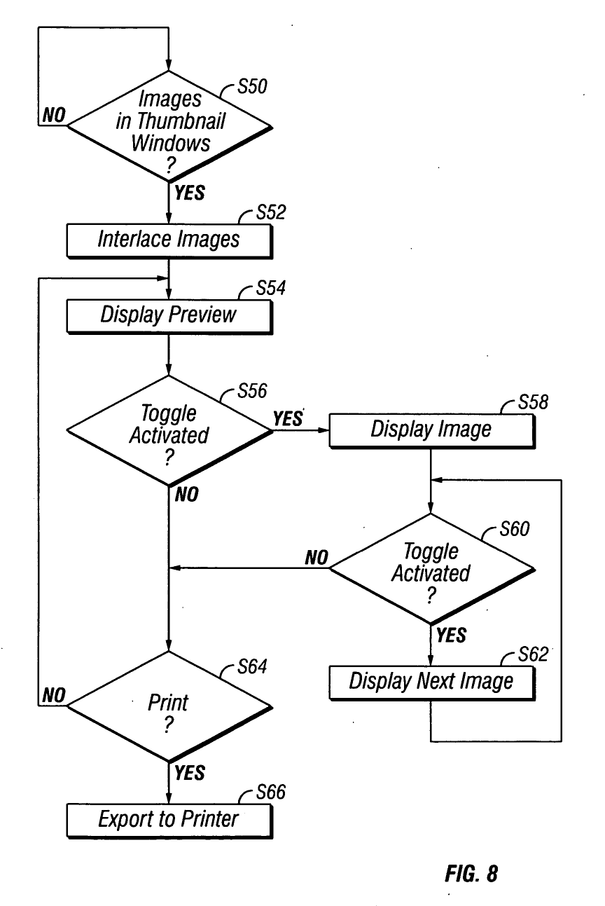

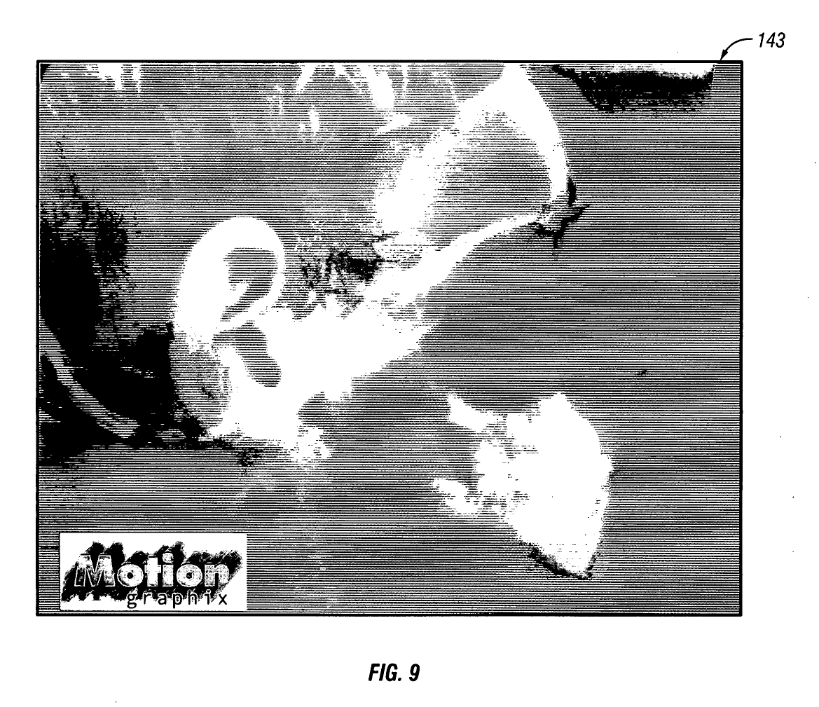

With additional reference to FIG. 8, when an image has been imported into each of the thumbnail windows 138 (step S50), then the code causes the computer 102 to interlace the images (step S52) and to display a preview (step S54) of an interlaced image in a preview window 142 of the screen 130. As known in the art, an interlaced image 143 is created by deleting horizontal rows of pixels from the images at regular intervals, and then superimposing the images together as shown in FIG. 9. Accordingly, for 2-flip animation, one-half of the interlaced image is from a first image, while the other half is from the second image. In general, the interlaced image is a processed image based on the images imported to the thumbnail windows 138.

Upon previewing the interlaced image (step U54), the user may modify one or more of the images in the thumbnail windows 138 or adjust how the image fits in each thumbnail window 138 by utilizing radio buttons 144. For example, a computer-determined best fit may be selected, or height or width adjustments may be selected. The image may also be flipped or rotated using appropriate menus on a menu bar 146 of the screen 130.

If 2- or 3-flip mode is selected, a user may toggle (step U56) between the images for viewing in the preview window 142 by clicking a toggle button 148. If clicked (step S56), a first image is displayed (step S58) in the preview window 142. If clicked again (step S60), a subsequent image is displayed (step S62). A preview button 150 may be clicked to view the interlaced image again.

The user may then print (step U58) the interlaced image when satisfied by the preview. A print button 152 may be provided which, when activated (step S64), causes the computer 162 to export (step S64) the interlaced image to the printer 108, thereby providing a print 154. The interlaced image may also be saved (step U60), for which a save button 156 may be provided. A user may select a desired print size with radio buttons 158, for example, 8 inches by 10 inches or 5 inches by 7 inches. An alignment mark button 160 may be activated so that an alignment mark is printed on the print 154, which is discussed below.

If 3D mode is selected, then up to five images may be imported into the thumbnail windows 138 of the mode window 136 as shown in FIG. 6. For a proper 3D print, the imported images are preferably separated by about 5 degrees of rotation, as appreciated by those skilled in the art. For proper 3D prints, a resolution of 40 lines per inch (lpi) should be selected at resolution radio buttons 162, while 30 lpi should be selected for proper flip animation. The user may export (step U62) to the anaglyph mode for preview and modification if desired.

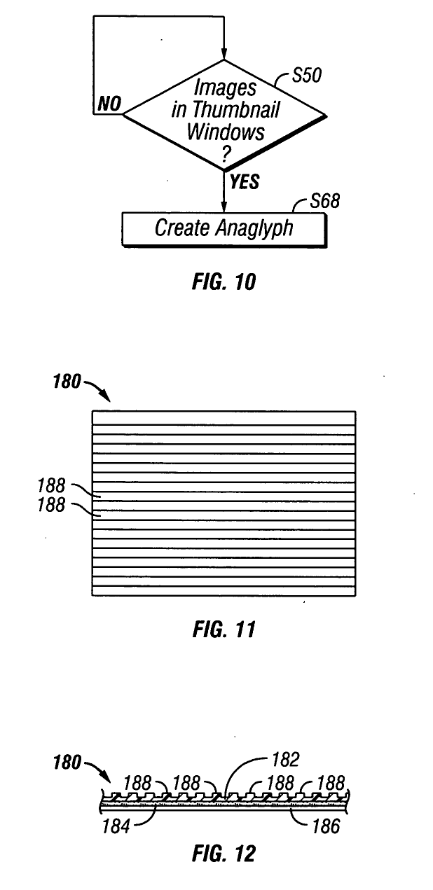

If anaglyph mode is selected, import buttons 164 may be utilized to import images from the 2-flip mode or the 3D mode. Referencing FIG. 10, when the images are in the thumbnail windows 138 (step S50), then the computer 102 creates an anaglyph (step S68) including a right view and a left view each of a corresponding color (i.e., red and blue). A user may adjust an image convergence (step U64) of the anaglyph. This may be done by adjusting the vertical positioning of each view with adjustment buttons 166 and/or the horizontal position of the anaglyph within the preview window with an window adjustment scroll bar 168. A zero button 170 may be provided to center the image horizontally. In addition, a color anaglyph button 172 may be selected to create a color anaglyph if desired by a user, as opposed to a black-and-white anaglyph, and a full-screen button 172 may be provided so that the preview may be viewed full screen on the monitor 106.

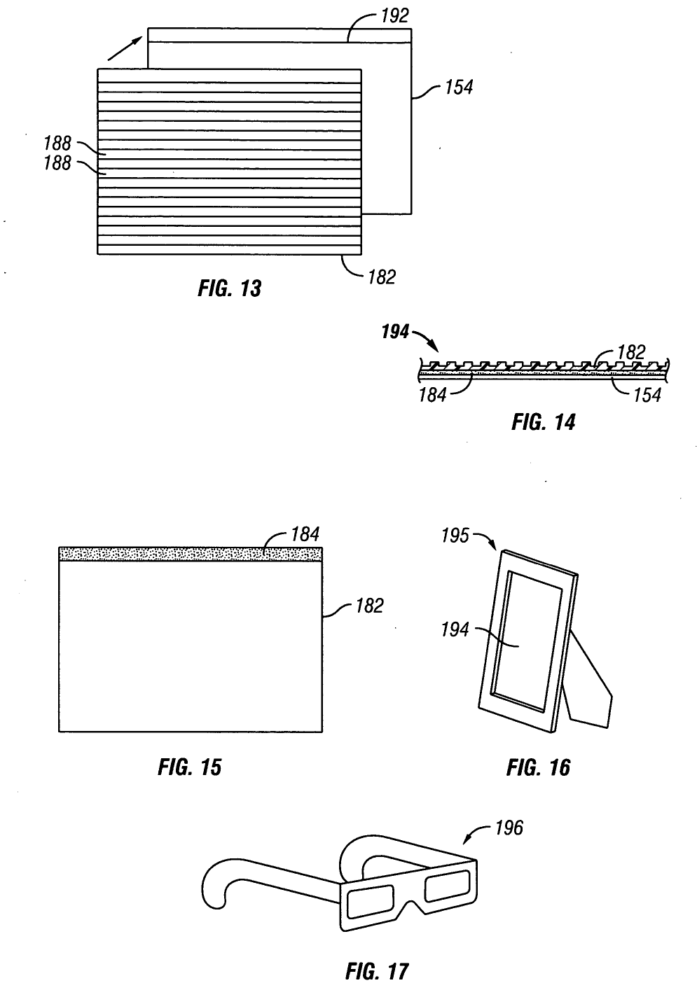

If 2-flip, 3-flip, or 3D mode is selected, the resultant print 154 may then be mounted (step U66) for proper viewing by utilizing a lenticular assembly 180 as illustrated in FIGS. 11 and 12. Exemplary lenticular assembly 180 includes a lenticular sheet 182 with an adhesive layer 184 and a removable backing sheet 186. A user may peel away the backing sheet 186 to expose the adhesive layer 184. The print 154 may then be mounted to the lenticular sheet 182 by positioning the print 154 against the adhesive layer 184, thereby adhering the print to the adhesive. As mentioned above and as shown in FIG. 13, an alignment mark 192 may be printed on the print 154 to aid the user in aligning the interlaced image of the print 154 with the lenses 188 of the lenticular sheet 182. A flip animated device 194 as shown in FIG. 14 results.

As shown in FIG. 15, the adhesive layer 184 may be in the form of a strip along one of the sides of the lenticular sheet 182. As shown in FIG. 16, a user may then mount the animated device 194 within a frame 195 for display and for holding the print 154 flat against the lenticular sheet 182. According to a preferred embodiment, the adhesive layer 184 may include pressure-sensitive adhesive so that the print 154 may be removed from the lenticular sheet 182 and repositioned thereon or, alternatively, replaced with another print if desired.

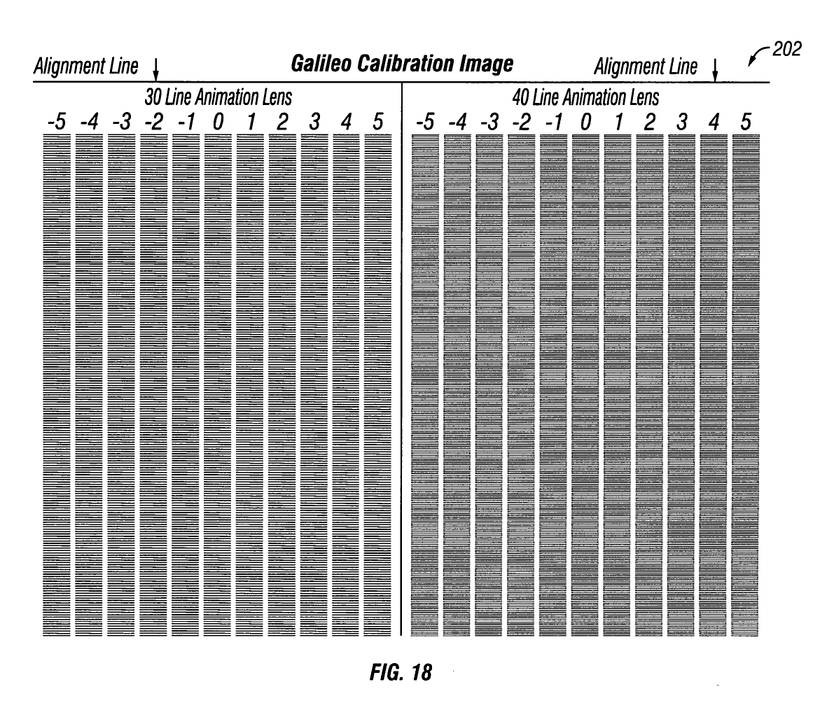

If the print 154 contains an anaglyph image, then the user may utilize stereo viewing glasses 196 as shown in FIG. 17 to view the image (step U68).

Referencing FIG. 1, if desired a user may add an overlay to the print 154 by utilizing an overlay button 198. An overlay may be an imported file for framing the image within the print 154. Alternatively, an overlay may be a logo printed on the print. In any case, the overlay is an image file that is not processed in creating the interlaced or anaglyph image.

In addition, the viewing distance may be adjusted by activating an adjust viewing distance button 200. The viewing distance is the distance a user views the animated or 3D device 194. If the viewing distance is not correct, the images may not have proper rolling animation or may ghost.

According to a preferred commercial embodiment of the invention, a kit including materials for producing animated and 3D devices may be provided. The kit may include one or more lenticular assemblies 180 (of varying resolution, e.g., 30 lpi and 40 lpi) and a pair of the stereo viewing glasses 196. In addition, the kit may include software code in the form of a plurality of computer readable instructions stored on a data storage medium, such as a CD-ROM 118 or a flopping disc 120. As mentioned above, the kit may include a web address so that the software code may be downloaded from a web site on the Internet. The kit may also include, a calibration sheet 202 as shown in FIG. 18 that may be used to calibrate the lenticular sheets 182.

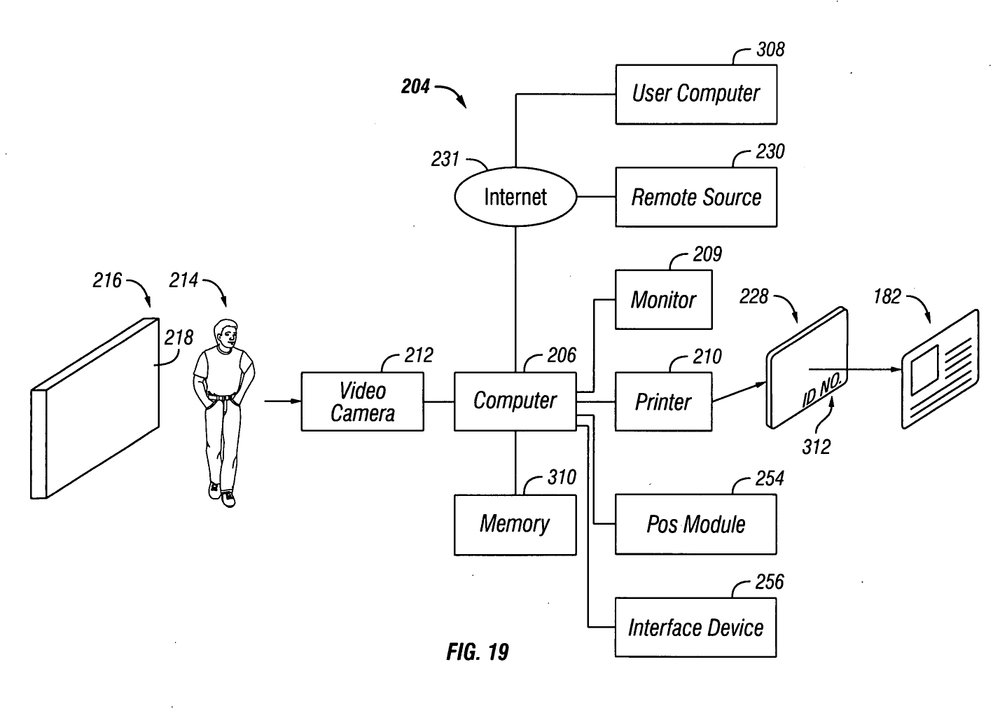

In addition to the foregoing embodiments in which still images are imported and processed, the present invention also provides systems and methods for producing three-dimensional and animated images utilizing live-feed video capture. More specifically, a system 204 for producing such images is illustrated in FIG. 19.

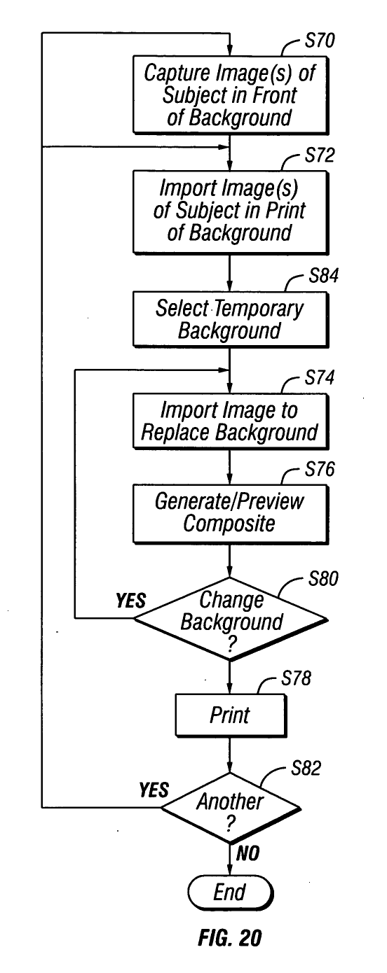

According to a number of embodiments, the system 204 may include a computer 206 connected to a video camera 208 (preferably a digital video camera), a monitor 209, and a printer 210. With additional reference to FIG. 20, the video camera 208 captures images of a subject 214 in front of a backdrop 216 with a background 218 (step S70). The backdrop 216 may be, for example, a canvas backdrop or a video backdrop.

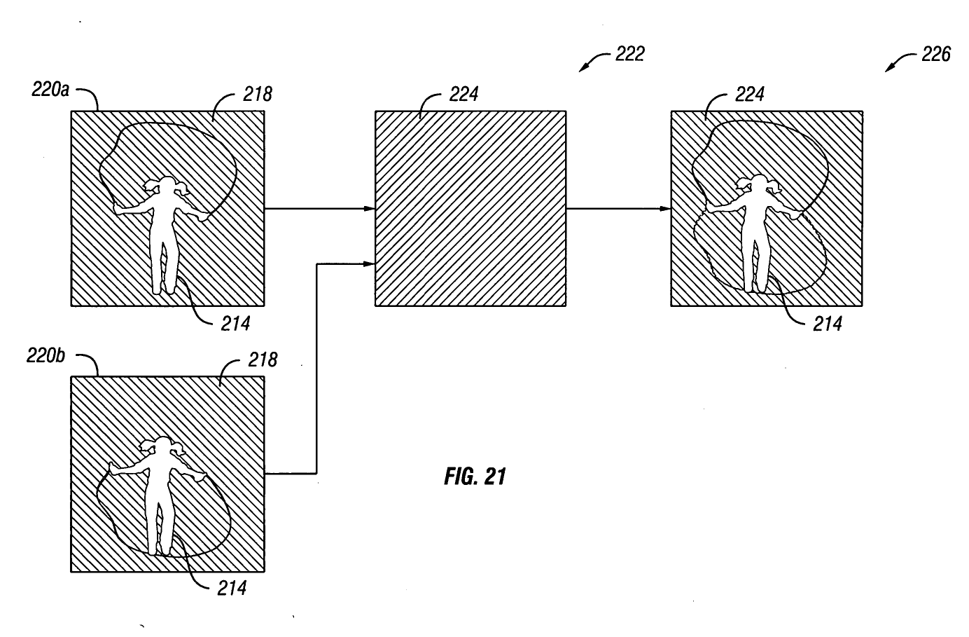

For the purposes of this description, the images captured by the video camera 208 will be called “subject images,” which are illustrated in FIG. 21 and indicated by reference numeral 220. Each of the subject images 220 includes an image of the subject 214 in front of the background 218. As discussed in more detail below, the background 218 of the subject images 220 can be replaced; therefore, the background 218 may be a temporary background of the subject image 220. According to some of the embodiments, the subject 214 is in a different orientation in each of the subject images 220. For example, in subject image 220a, the arms of the subject 214 are raised, while in subject image 220b, the arms of the subject 214 are lowered.

After capture, the subject images 220 are imported into the computer 206 (step S72). In accordance with the foregoing description, a plurality of the subject images 220 may be imported into the thumbnail windows 138 (see, e.g., FIG. 2). The computer 206 may then import a background image 222 with a replacement background 224 (step S74). The background image 222 may also be displayed in a thumbnail window 138 on the monitor 209.

According to the invention, the computer 206 then generates a composite image 226 by replacing the temporary background 218 of the subject images 220 with the replacement background 224 and by interlacing the subject images 220 (step S76). The computer 206 may then cause the printer 210 to generate a print 228 of the composite image 226. The print 228 may then be mounted to a lenticular sheet 182 as described above.

Prior to printing, the computer 206 may display the composite image 226 in the preview window 142 on the monitor 209. If desired, a user may change the background 224 (step S80) to another replacement background by importing another background image 222 (step S74). The background images 222, as well as the subject images 220, may be imported from a storage device connected to the computer 206, such as a hard drive, or from a remote image source 230, e.g., via the Internet 231. In addition, after generating the print 228, a user may repeat the entire process any number of times (step S82) as desired.

In a number of embodiments, the temporary background 218 may be a uniformly or evenly colored background or a monochromatic background. An example of such a background is a “green screen” background. In a number of embodiments, after the subject images 220 are imported, the computer 206 may enable the user to select which of the colors in the background will be defined as the temporary background 218 (step S84), for example, with an eye-dropper tool or specific RGB color input. Accordingly, when the replacement image 222 is imported, then only the selected temporary background 218 will be replaced.

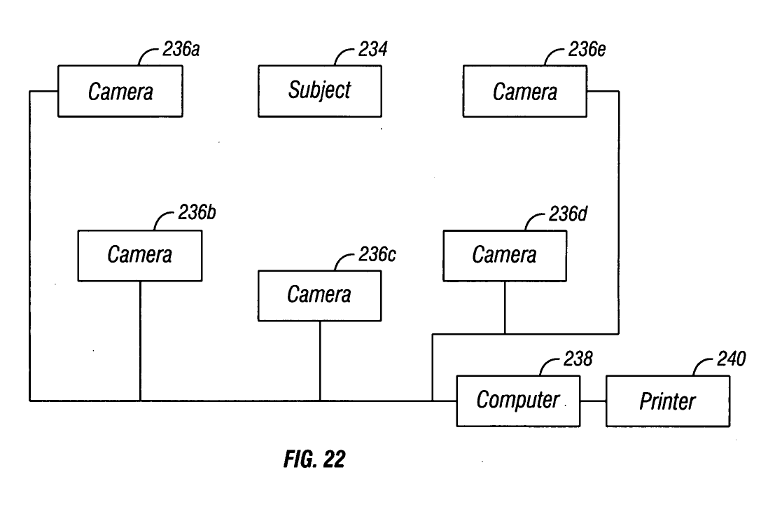

According to a number of other embodiments of the invention, a system 232 for creating a three-dimensional image of a subject 234 is illustrated in FIG. 22. Exemplary system 232 may include a plurality of cameras 236 disposed about the subject 234 each for capturing an image of the subject 234 from a different angle. The system 232 also includes a computer 238 connected to a printer 240.

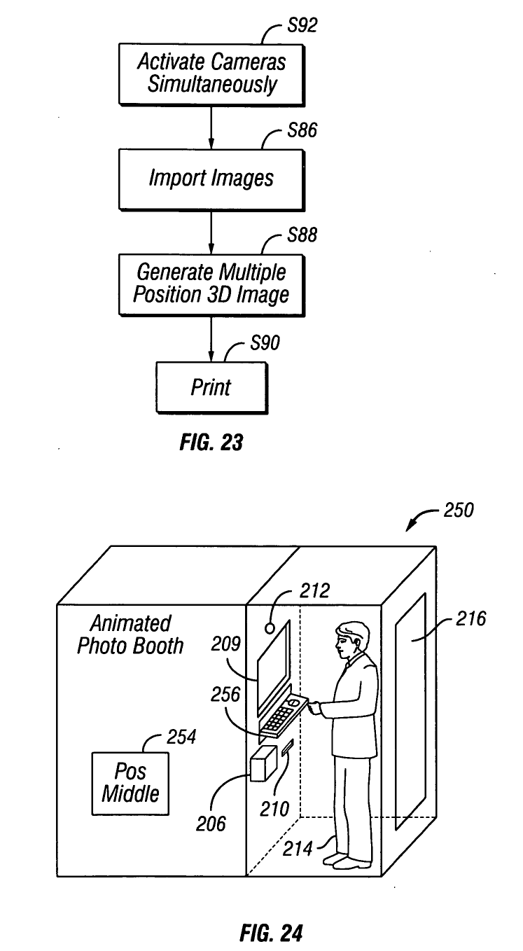

With additional reference to FIG. 23, the computer 238 imports the plurality of images (step S86) from the cameras 236 and then generates a composite image (step S88) based on the plurality of images. The computer 238 may then generate a print of the composite image analogous to that described above on the printer 240.

According to a number of embodiments, the cameras 236 are digital cameras operatively connected to the computer 238 as shown in FIG. 22 so that the images may be directly loaded into the computer. In addition, the plurality of cameras 236 may be activated substantially simultaneously (step S92) so that the plurality of images represent the subject from multiple angles at substantially the same instance in time.

In the example shown in FIG. 22, the cameras 236 are disposed about the subject 234 so that five images are produced. The cameras 236 may be disposed at predetermined locations. For examples, cameras 236a and 236e are disposed on opposite sides of the subject 234 (i.e., on the left and right sides of the subject), while camera 236c is approximately 90 degrees offset (or between) cameras 236a and 236e (i.e., in front of or aligned with the subject). Further, cameras 236b and 236d are disposed between camera 236c and cameras 236a and 236e, respectively.

In a number of embodiments, the principles of the invention may be incorporated into a photography system 250 as shown in FIG. 24. The photography system 250 may be implemented as a “stand alone” system in which a user 214 is able to generate a print of himself or herself. The user may then apply the print to a lenticular assembly to create an animated device if desired.

The stand-alone system 250 may be implemented as a photo booth-type installation with a point-of-sale (POS) module 254 as shown in FIG. 24. The POS module 254 may be configured to receive payment by cash, coin, token, and credit or debit cards. Accordingly, the photo system 250 may placed in public areas as an amusement for generating revenue without the need of a dedicated operator.

With continued reference to FIG. 24 and further reference to FIG. 19, in addition to the POS module 214, the photo system 230 may include a monitor 209, a printer 210, a backdrop 216 having a background 218, a camera 212 directed at the backdrop, and a computer 206 connected to each of these devices. An interface device 256 such as a keyboard or a mouse may also be provided.

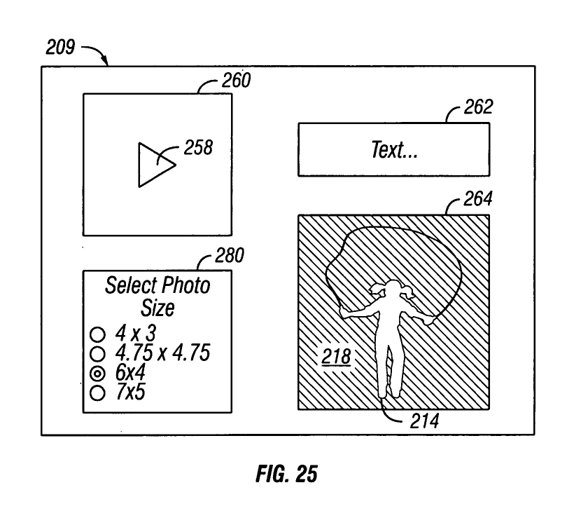

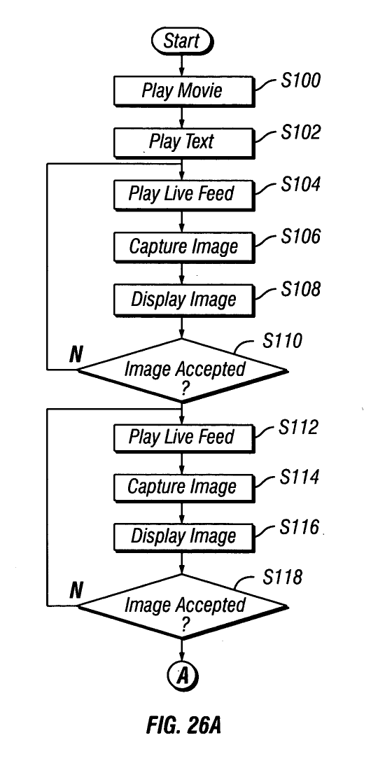

With additional reference to FIGS. 25 and 26, according to some of the embodiments, the computer 206 may play an instructional movie 258 (step S100) on the monitor 209 for instructing the user 214 how to use the system. The computer 209 may display the movie 258 within a movie window 260 on the monitor 209. According to the invention, the instructional movie 214 guides a user 214 through the process of generating animated images. The computer 206 may also display text (step S102) corresponding to the instructional movie 214 within a text window 262.

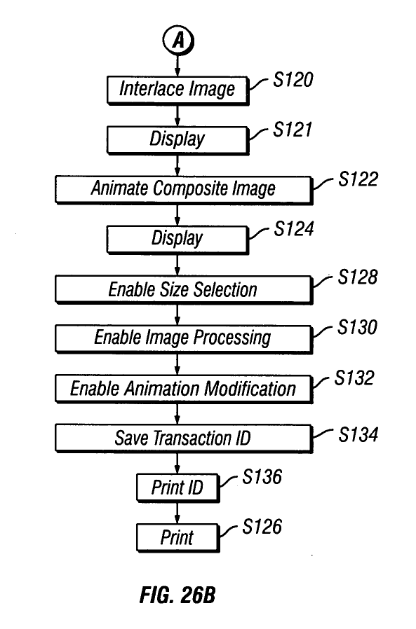

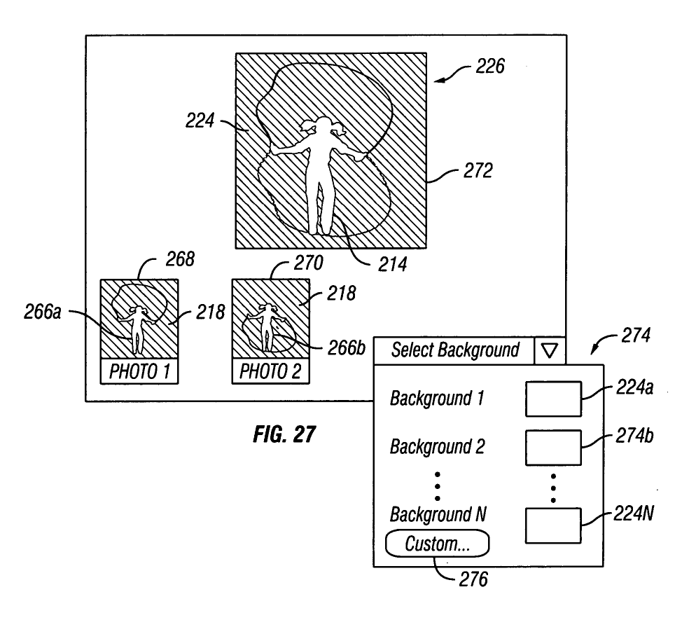

In addition, the computer 209 may also play a live feed (step S104) from the video camera 212 on the monitor 209, e.g., within a display window 264. The live feed shows the user 214 in front of the background 218 of the backdrop. The instructional movie 258 may instruct the user 214 to prepare for a first photograph and may, for example, provide a countdown until the time the computer 209 captures from the video camera 212 the first photograph, i.e., a first subject image (step S106). The computer 206 may then display the captured image 266a (step S108), for example, in a thumbnail window 268 as shown in FIG. 27.

The instructional movie 258 may then query the user whether the captured image 266a is satisfactory (at step S110). The user may then provide an input to either accept or reject the captured image, for example, by means of the interface device 256, by touching an appropriate place on the monitor 209, or by voice activation. If rejected, the computer 206 may return to the live video feed at S104.

If the first captured subject image 266a is accepted, then the computer 206 may then display the live feed (step S112) again in display window 264. The instructional movie 258 may then instruct the user 214 to prepare for a second photograph. The computer 209 then captures from the video camera 212 the second photograph, i.e., a second subject image (step S114). The computer 206 may then display the second captured subject image 266b (step S1166), for example, in a thumbnail window 270.

The instructional movie 258 may then query the user whether the second captured subject image 266b is satisfactory (at step S118). If rejected, the computer 206 may return to the live video feed at S112. If the second captured subject image 266a is accepted, then the computer 206 may then generate a composite image by initially interlacing the captured subject images 266, which composite image 226 may be displayed in preview window 272 (step S121). In addition, the computer 206 may animate composite image 226 (step S122) so that the user can preview the results. The computer 206 may provide the option of replacing either one or both of the captured subject images 266, if desired, by returning to a live feed (either at S104 or S112).

As mentioned, the subject images 266 include the subject 214 in front of the temporary background 218. The computer 206 may then replace the temporary background 218 with a replacement background 224. In a number of embodiments, the computer 206 may provide the option to the user of selecting a desired replacement background (step S122). For example, the computer 206 may display in a pop-up window 274 a plurality of replacement backgrounds 224a, 224b, . . . 224n from which the user 214 may select a replacement background. Alternatively, the user may import a preferred replacement background from a remote source 230 with, e.g., a custom key 276. The composite image 226 with the replacement background 224 may then be displayed in preview window 272 (step S124). At this time the user 214 may cause the computer 209 to print the composite image 226 (step S126) analogous to that described above to yield a print 228.

In addition to providing the user with the ability to selected a preferred replacement background, in a number of embodiments the computer 206 may be configured to enable the user to further customize and enhance the composite image 226 and resulting print 228. For example, as shown in FIG. 25, the computer 206 may display a size-selection window 280, e.g., with a plurality of preset sizes, so that a user can select the desired size of the print 228 (step S128).

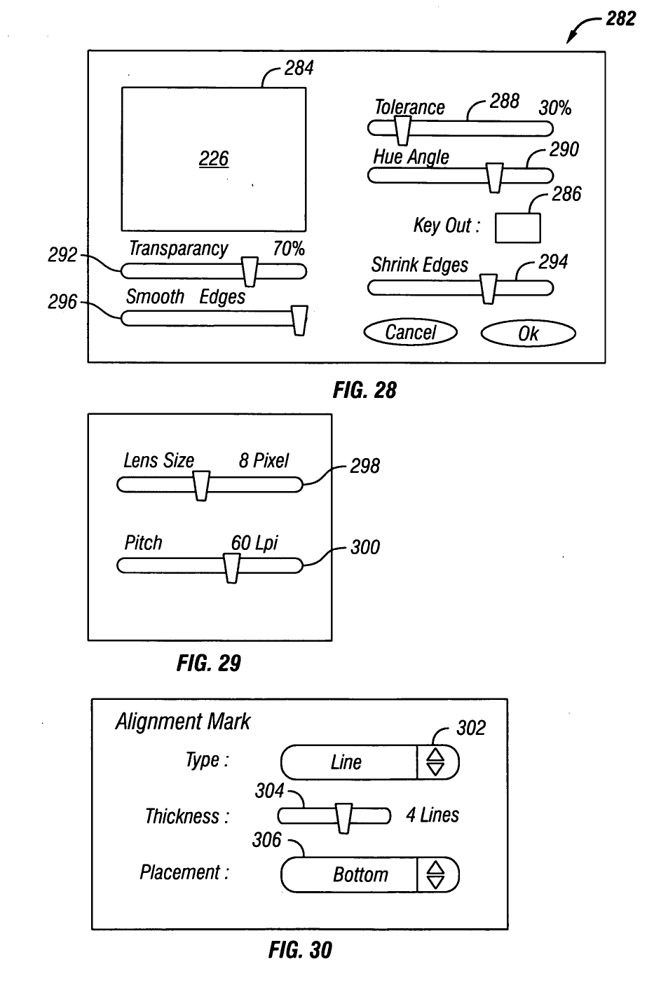

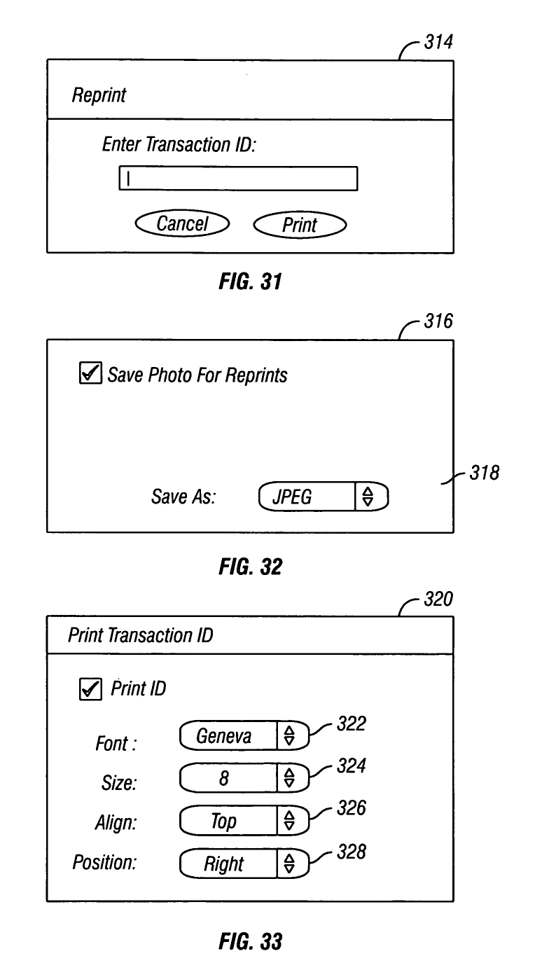

The computer 206 may also be configured to enable the user to process the composite image 226 (step S130). For example, referring to FIG. 28, an image processing window 282 may be displayed on the monitor 209, including a preview window 284 for displaying the composite image 226. Exemplary image-processing window 282 may include a number of tools for allowing the user to change aspects of the composite image 226.

For example, a key-out tool 286 may be provide to allow the user to select a color in the background 224 to be removed from the composite image 226. Related to the key-out feature, the processing window 282 may also include a tolerance tool 288 for allowing the intensity of the keyed-out color to be varied. In addition, a hue-angle tool 290 may be provided for allowing the location and the angle of the keyed-out color to be varied. Further, a transparency tool 292 may be provided to allow the degree of removal of the keyed-out color to be varied.

In addition to the background processing tools, window 282 may include an edge-shrinking tool 294 for enabling the edges of the composite image 226 to be reduced, thereby magnifying the subject 214 in the resulting print 228. An edge-smoothing tool 296 may be provided for varying the smoothness of the edges remaining after utilizing the shrinking tool 294.

Referring to FIGS. 29 and 30, the computer 206 may also be configured to enable the user to customize features of the print 228 relating to animation (step S132). More specifically, as shown in FIG. 29, the computer 206 may provide a lens-size tool 298 for selecting the number of pixels on the lens 182 to which the print 228 is to be applied. In addition, a pitch tool 300 may be provided for allowing the pitch, e.g., in lines per inch (lpi), of the lens 182 to be selected.

As shown in FIG. 30, the computer 206 may also enable the user to modify the printing of the alignment mark 192 (see FIG. 13). For example, the type of alignment mark may be selected with a type-selection tool 302. In addition, a thickness tool 304 may be provided so that the thickness of the alignment mark 192 may be modified. Further, a placement tool 306 allows the user to select where to place the alignment mark 192 on the print 228.

As mentioned above, the photo system 250 may include a POS module 254 to enable commercial transactions. In a number of embodiments, the computer 206 may be configured to enable the user not only to generate the print 228 at the photo system 250 itself but also at a remote user computer 308 via the Internet 231 as shown in FIG. 19. To enable remote generation of prints 228, the computer 206 may maintain in memory 310 a transaction identification number associated with the composite image 226 (step S134), which transaction ID may be printed on the print 228, e.g., as shown at 312 in FIG. 19 (step S136).

Accordingly, if the user desires to generate another print 228, the user may access from the user computer 308 a website associated with the photo system 250. The transaction ID 312 may be entered in a window 314 to retrieve the composite image 226 associated with the ID 312 from the memory 310. The user may then print the composite image 226 on his or her own printer.

In this regard, the computer 206 may provide the user the option of saving the composite image 226 in memory 310, for example, with a save window 316 as shown in FIG. 32. The user may be provided with the option of what type of image file is to be saved with a selection tool 318. In addition, the computer 206 may be configured to enable the user to select whether or not the transaction ID is to be printed on the print 228 with an ID option window 320 as shown in FIG. 33. Window 320 may include a font type tool 322 and a font size tool 324 for modifying the font of the transaction ID 312. In addition, an alignment tool 326 and a position tool 328 may be provided to allow the user to select where the ID 312 is to be located on the print 228.

Returning to FIGS. 24 and 25, in a number of embodiments a plurality of instructional movies 258 may be stored in memory 310. Each of the movies 258 may have a particular theme. For example, if the photo system 250 is to be installed in a children's amusement park, then the instructional movie 258 may have a children's theme. Alternatively, if the photo system 250 is to be installed on a cruise ship, then the instructional movie 258 may have a nautical theme. Accordingly, the photo system 250 is versatile in that while all of the hardware and software may remain the same regardless of the installation, the theme of the instructional movie 258 may be varied to complement a particular installation.

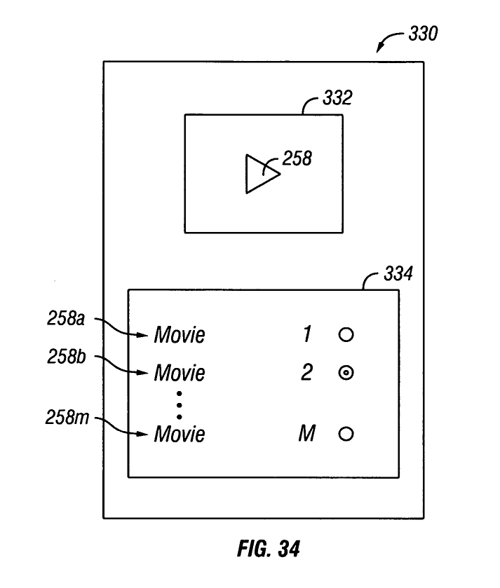

In this regard, the computer 206 may display a movie selection window 330 with a preview window 332 and a selection window 334 with a plurality of instructional movies 258a, 258b, . . . 258m, as shown in FIG. 34. A vendor may then select one of the movies 258 and preview the selected movie. The vendor may then choose which of the movies 258 is appropriate for a particular installation of the photo system 250.

Those skilled in the art will understand that the preceding exemplary embodiments of the present invention provide the foundation for numerous alternatives and modifications thereto. These other modifications are also within the scope of the present invention such that the present invention is not limited to that precisely as shown and described in the present invention.

What is claimed is:

1. A method for creating three-dimensional or animated images, the method comprising:
a) causing a computer to import a subject image including a subject and a temporary background;
b) causing the computer to generate a composite image by replacing the temporary background of the subject image with a replacement background; and
c) causing the computer to generate a print of the composite image.

2. A method as claimed in claim 1 wherein step (a) further includes causing the computer to import a plurality of subject images;
the composite image being generated by replacing the temporary background of each of the subject images with the replacement background.

3. A method as claimed in claim 2 wherein the temporary background in each of the subject images is a green-screen background.

4. A method as claimed in claim 2 further comprising capturing the plurality of subject images with a video camera.

5. A method as claimed in claim 2 wherein the subject and the temporary background are the same for each of the subject images, the subject being in a different orientation in each of the subject images.

6. A method as claimed in claim 5 wherein step (b) further includes causing the computer to generate the composite by interlacing at least two of the subject images.

7. A method as claimed in claim 6 further comprising mounting the print to a lenticular sheet.

8. A method as claimed in claim 1 further comprising causing a computer to import a background image including the replacement background.

9. A method as claimed in claim 8 wherein the background image is imported from a remote source.

10. A method as claimed in claim 1 further comprising repeating step (a) to step (c) a plurality of times.

11. A system for producing a three-dimensional or an animated device, the system comprising:
a printer;
a monitor;
a computer connected to the printer and the monitor, the computer for:
displaying a preview window and a plurality of thumbnail windows on the monitor;
importing a plurality of subject images to the plurality of thumbnail windows, respectively, each of the subject images including a subject and a temporary background, the subject of each of the images being in a different orientation;
replacing the temporary background in each of the subject images with a replacement background;
generating a composite image by interlacing at least two of the subject images; and
causing the printer to generate a print of the composite image; and
a lenticular assembly including a lenticular sheet with an adhesive layer for receiving the print from the printer.

12. A system as claimed in claim 11 wherein the temporary background of the subject images is a green-screen background.

13. A system as claimed in claim 11 further comprising a video camera connected to the computer, wherein the computer imports the subject images from the digital camera.

14. A system as claimed in claim 13 further comprising a backdrop, wherein the video camera captures the subject images of the subject in front of the backdrop.

15. A system as claimed in claim 14 wherein the backdrop is a green-screen backdrop.

16. A system as claimed in claim 15 wherein the backdrop is a canvas backdrop.

17. A system as claimed in claim 11 wherein the computer imports a background image including the replacement background.

18. A system as claimed in claim 17 wherein the computer imports the background image from a remote source.

19. A system as claimed in claim 11 further comprising a plurality of lenticular assemblies, wherein the computer repeats the steps a plurality of times.

20. A method for creating a three-dimensional image of a subject, the method comprising:
capturing a plurality of images of the subject each from a different angle;
causing a computer to import the plurality of images;
causing the computer to generate a composite image based on the plurality of images; and
causing the computer to generate a print of the composite image.

21. A method as claimed in claim 20 wherein the capturing step further includes capturing the plurality of image substantially simultaneously.

22. A system for creating a three-dimensional image of a subject, the system comprising:
a plurality of cameras disposed about the subject each for capturing an image of the subject from a different angle; and
a computer for:
importing the plurality of images;
generating a composite image based on the plurality of images; and
generating a print of the composite image.

23. A system as claimed in claim 22 wherein each of the cameras is a digital camera operatively connected to the computer so that the computer is able to import the images from the digital cameras.

24. A system as claimed in claim 22 further comprising a printer connected to the computer for printing the print.

25. A photography system for generating a print of a user, the system comprising:
a printer;
a monitor;
a backdrop having a background;
a camera directed at the backdrop; and
a computer connected to the printer, the monitor, and the video camera, the computer for:
playing an instructional movie on the monitor for instructing the subject how to use the system; and
playing a live feed from the video camera on the monitor;
capturing a first subject image of the user in front of the backdrop from the video camera;
capturing a second subject image of the user in front of the backdrop from the video camera;
generating a composite image by:
interlacing the subject images; and
replacing the background of the backdrop with a replacement background; and
causing the printer to generate a print of the composite image.

26. A system as claimed in claim 25 further comprising a lenticular assembly including a lenticular sheet with an adhesive layer for receiving the print.

27. A system as claimed in claim 25 wherein the background of the backdrop is a monochromatic background.

28. A system as claimed in claim 25 further comprising a point-of-sale module connected to the computer.

29. A system as claimed in claim 25 wherein the computer includes memory for storing a plurality of instructional movies.

30. A system as claimed in claim 25 wherein the computer includes memory for storing a plurality of replacement backgrounds.

31. A system as claimed in claim 25 wherein the computer includes memory for storing a transaction ID associated with the composite image.

32. A system as claimed in claim 25 further comprising an interface device for allowing the user to interface with the computer.

33. A system as claimed in claim 25 wherein the computer is configured to allow the user to modifying aspects of the composite image prior to printing.
